(19) United States
(12) Patent Application Publication
(10) Pub. No.: US 2011/0192263 A1
(43) Pub. Date: Aug. 11, 2011

(54) Equipment For Transversal Perforation, On The Fly, Of Continuous Forms In Movement

(75) Inventors: Giuliano De Marco, Ivrea (TO) (IT); Armando Aprato, Ivrea (TO) (IT); Francesco Terrusi, Ivrea (TO) (IT); Francesco Modica, Ivrea (TO) (IT)

(73) Assignee: Tecnau S.r.l., Ivrea (TO) (IT)

(21) Appl. No.: 13/021,857

(22) Filed: Feb. 7, 2011

(30) Foreign Application Priority Data
Feb. 8, 2010 (IT) TO2010A000084

(51) Int. Cl. B26D 1/40

(52) U.S. Cl. 83/343

(57) ABSTRACT

Equipment for transversal perforation, on the fly, of continuous forms in movement, comprises a perforating device having a blade support with a perforating blade, which is actuated for the rotation by a blade servomechanism, in synchronism with the form for the perforation. A contrast member including active sections and remaining inactive sections is rotated by a contrast servomechanism parallel to the support blade. In a condition of perforation, each active section, in synchronism with the form, can provide function of contrast for the perforation blade. In a condition of non-perforation, each inactive section is spaced away from a surface of movement of the form, whereby avoiding the perforation on the passage of the blade.

### RELATED APPLICATION

This application claims priority to Italian Application No. TO2010A000084 filed Feb. 8, 2010, and entitled “Equipment For Transversal Perforation, On The Fly, Of Continuous Forms In Movement,” the content of which is incorporated herein by reference in its entirety.

### FIELD OF THE INVENTION

The present invention relates to an equipment for transversal perforation, on the fly, of continuous forms in movement.

Specifically, the invention relates to an equipment for, on the fly, transversal perforation of continuous forms in movement, comprising a perforating device with at least a perforating blade, mounted on a blade support and a blade servomechanism for rotating the blade support with the perforating blade in synchronism with the form and perforation in a requested position.

### BACKGROUND OF THE INVENTION

Transversal perforating equipments are used in systems for the automatic processing of documents for carrying out transversal perforations which make easy the tear, aside predefined. The documents are generally derived from continuous paper forms, downstream from printers and/or high-speed unwinding devices.

The current printers reach printing velocity which can result higher than the velocities of the perforating equipments arranged downstream of the printers. The difference between the printing velocity and the perforation velocity is further greater when the perforations to be carried out are close each the other. It lessens the speed of the system in which the perforating device is used.

An equipment of the above mentioned type is known from European patent application EP1 484 145 in the name of Tecnau S.r.l. This known equipment uses two blade supports and contrast rollers arranged, one behind the other, along the direction of movement of the form. The equipment effectively works with large possibility of positioning of the perforations in the obtainable documents either on the whole width of the form and on the halves of the form when the form is subject to longitudinal separation.

A similar perforating device has been disclosed in the Italian patent application TO 2009A000102, filed on Feb. 11, 2009 in the name of Tecnau S.r.l. In particular, this device includes a reciprocal shifting mechanism between the blade support and the contrast roller. The blade support, also servocontrolled, mounts two blades for achieving different typologies of perforations. The reciprocal shifting mechanism is put in the condition of interference of one of the blades to achieve the typology of perforation associated with the same blade and in the inoperative condition for the other blade. The device works at a very high velocity either with perforations close each the other, and with long spaced perforations and allows a large possibility of use with continuous forms of different typologies. In detail, the device can perforate forms to be divided in three longitudinal sections and forms to be divided in two longitudinal sections.

The known perforating devices present problems, in the phases of initialization, because of the start time needed to put the rotating velocity of the contrast roller to the feeding velocity of the form. It is penalizing in the case in which the perforating device is downstream of a high-speed printer, which works in intermittent way. Moreover, the mechanism for the reciprocal movement between contrast roller and perforating blades is inherently expensive.

### SUMMARY OF THE INVENTION

An object of the present invention is to carry out a transversal perforating device on the fly for continuous forms in movement, which has the possibility of achieving, at high velocity, with limited costs and great flexibility, transversal perforations, both close and spaced each the other.

According to such object, the equipment for transversal perforation, on the fly, for continuous forms includes a contrast member provided for rotation in condition of substantial parallelism with the blade support and having a section or more active sections and a section or more inactive remaining sections and a contrast servomechanism for rotating the contrast member between a condition of perforation and a condition of non-perforation. The active section or each active section can be positioned in condition of tangency with the trajectory of the perforating blade for defining the contrast surface in the operative area, while the inactive section or each inactive section is spaced away, in the use, with respect to the trajectory of the blade. The contrast servomechanism, for the condition of perforation, rotates the contrast member with the active section or one of the active sections in the condition of tangency with the operative area and in synchronism with the form while, for the condition of non-perforation, the contrast servomechanism positions the contrast member, at rest or in movement, with the inactive section or one of the inactive sections spaced away from the trajectory of the perforating blade in the operative area.

The characteristics of the invention will become clear from the following description given purely by way of non-limiting example, with reference to the appended drawings in which:

### BRIEF DESCRIPTION OF THE DRAWINGS

FIG. 1 represents a partial scheme of a previous transversal perforating equipment, on the fly, for continuous forms;

FIG. 2 shows schematically an example of a continuous form which can be processed by the equipment of FIG. 1;

FIG. 3 is an exploded schematic view of a perforating device used in the equipment represented in FIG. 1;

FIG. 4 represents an exploded schematic view of a perforating device used in an equipment for transversal perforation, on the fly, according to the invention;

FIGS. 5a±5e show different operative conditions of some parts of the perforating device represented in FIG. 4;

FIG. 6 is an example of a continuous form, which can be processed by the perforating device of FIG. 4;

FIGS. 7a±7e are different diagrams of the device of FIG. 4;

FIG. 8 represents another example of continuous form, which can be processed by the device of FIG. 4;

FIG. 9 represents a partial scheme of a perforating equipment according to the invention, for a given typology of continuous form;

FIG. 10 is a partial scheme of a perforating equipment according to the invention, for an alternative typology of continuous form;

FIG. 11 shows schematically an exploded plant view of some parts of the device represented in FIG. 4 for a particular mode of operation;

FIG. 11a is a front view of a detail of the device shown in FIG. 11;

FIG. 12 shows schematically an exploded plant view of a variant of some parts of FIG. 4 in the mode of operation of FIG. 11;

FIG. 13 shows a working condition of the parts of the perforating device of FIG. 4; and

FIG. 14 represents an exploded schematic view of the parts of FIG. 12.

### DESCRIPTION OF THE PREFERRED EMBODIMENTS

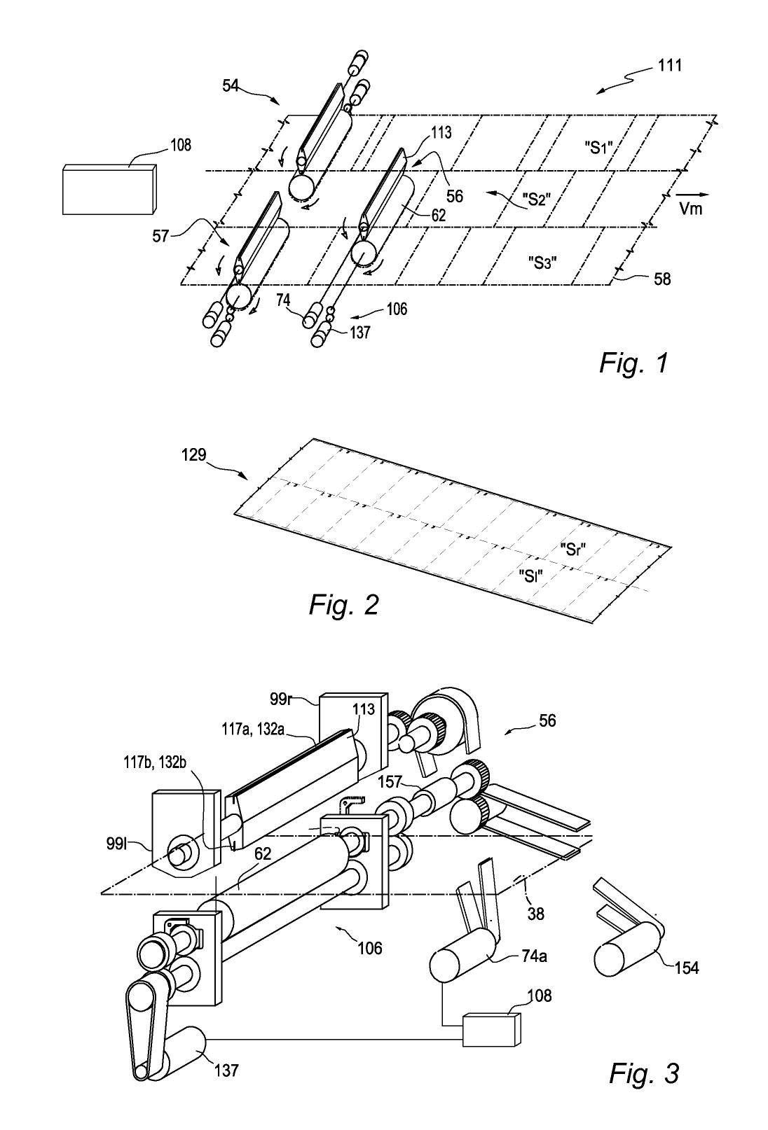

FIGS. 1, 2 and 3 represent a transversal perforating device 56 used in a perforating equipment 111 for a form 58 or a form 129. The form 58 is provided for being divided in three longitudinal sections “S1”, “S2” and “S3”, while the form 129 is provided for being divided in two longitudinal sections “Sr”, and “S1”. The perforating equipment 111 is the subject of the Italian patent application TO 2009A000102, filed on 11 Feb. 2009 in the name of Tecnau S.r.l, and whose content is here included for references. Specifically, the perforating device 56 works on the section “S2” of the form 58 or on the section “S1” of the form 129.

The perforating equipment 111 includes other two transversal perforating devices, 54 and 57, for the other sections “S1” and “S3” of the form 58 or for the other section “S1” of the form 129. The form 58, 129 is advanced at a constant velocity Vm. A position encoder, not shown in the figures, recognizes the position of the form, while a sensing device, also not shown, reads perforation codes associated with the positions of the perforations in the document.

In extreme synthesis, the perforating device 56 includes a blade support 113 having possibilities of mounting, with possibility of easy replacing, a pair of identical blades 117a, 117b or blades 132a, 132b different each the other. The blade support 113 is rotatable mounted between two sides 99r and 99l and is actuated by a blade servomechanism 74 or 74a driven by a control circuit member 108. The servomechanism 74 or 74a is provided for commutating the blade support 113 between an inoperative condition and a condition of perforation in which the perforating blade perforates the form 58, 129 against a contrast surface. The contrast surface is constituted by a roller 62, which is rotatable parallel to the axis of the blade support, in condition of tangency with a movement surface 38 of the form 58, 129 and peripheral velocity in synchronism with the velocity Vm of the form. The blade 117a, 117b; 132a, 132b is disengaged from the roller 62 in the inoperative condition, while it is interfering with the roller in the condition of perforation for executing the perforations.

For rotating the blade support 113, the servomechanism 74, 74a responds to the perforation codes of the form 58, 129 and to information by the position encoder. Thus, the blade 117a, 117b; 132a, 132b is caused to interfere with the roller 62 in the perforation positions, with peripheral velocity substantially equal to the velocity “Vm” of the form 58, 129.

The perforating device 56 further includes a reciprocal shifting mechanism 106 driven by the control member 108. The mechanism 106 is actuatable for adjusting the distance of the blade support 113 from the contrast roller 62 between a condition of perforation, of engagement of the blade 117a, 117b; 132a, 132b and an inoperative condition of disengagement of the blades. In detail, the mechanism 106 includes two eccentric cams driven by a shifting motor 137 and two cam follower rollers connected with the roller 62. A cycle of actuation of the motor 137 causes a rotation of 360° of the cams, with shifting in vertical of the roller 62 between the operative position and the non-operative position and return to the operative position. For the rotation, the contrast roller 62 is connected with a form feeding motor 154 through pulleys and toothed belt and a cardanic joint 157.

As described in the cited patent application TO 2009A000102, the blades 117a and 117b are of the same length and the control member 108 works on the mechanism 106 for “jumping” perforations in given positions of the form in movement. To reach higher velocity of perforation, after the perforation, the blade is kept in movement at a given basic velocity and can execute an idle run, with “jump”, when the distance between the perforations is high. The perforations with “jump” result noiseless and limit the stresses to which the various components of the perforating devices are submitted.

The blades 132a, 132b are of different length and the control member 108 works on the reciprocal shifting mechanism 106 for settling the condition of perforation of the blade 132a on a section of the form 58. In alternative, the control member 108 can settle the condition of perforation of the blade 132b on a section of the form 129.

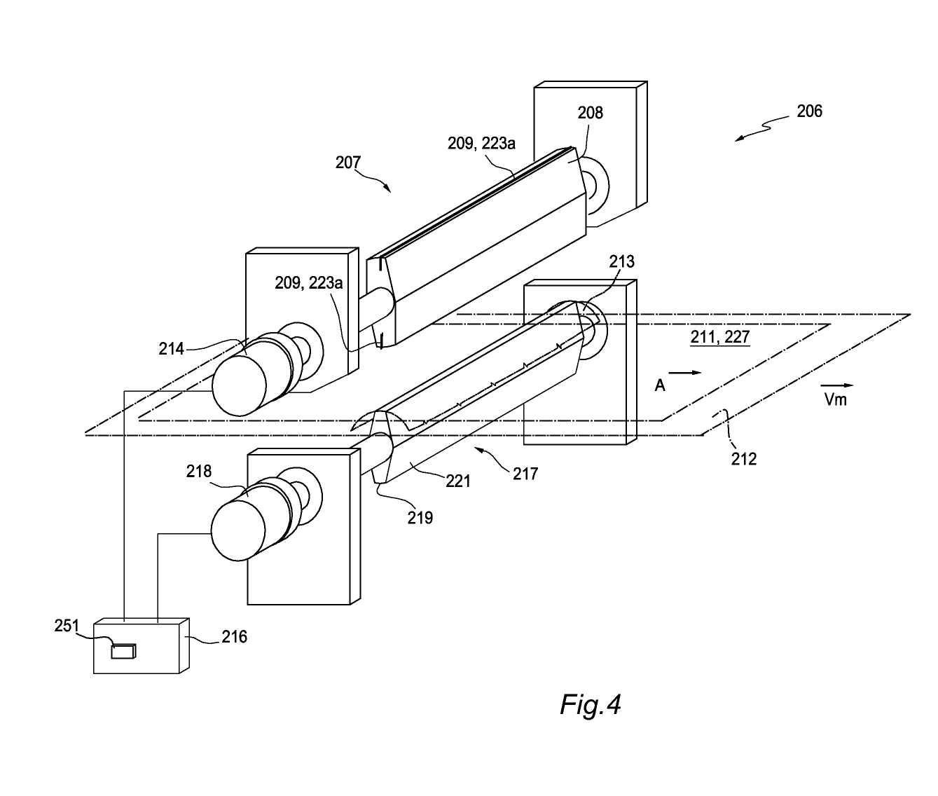

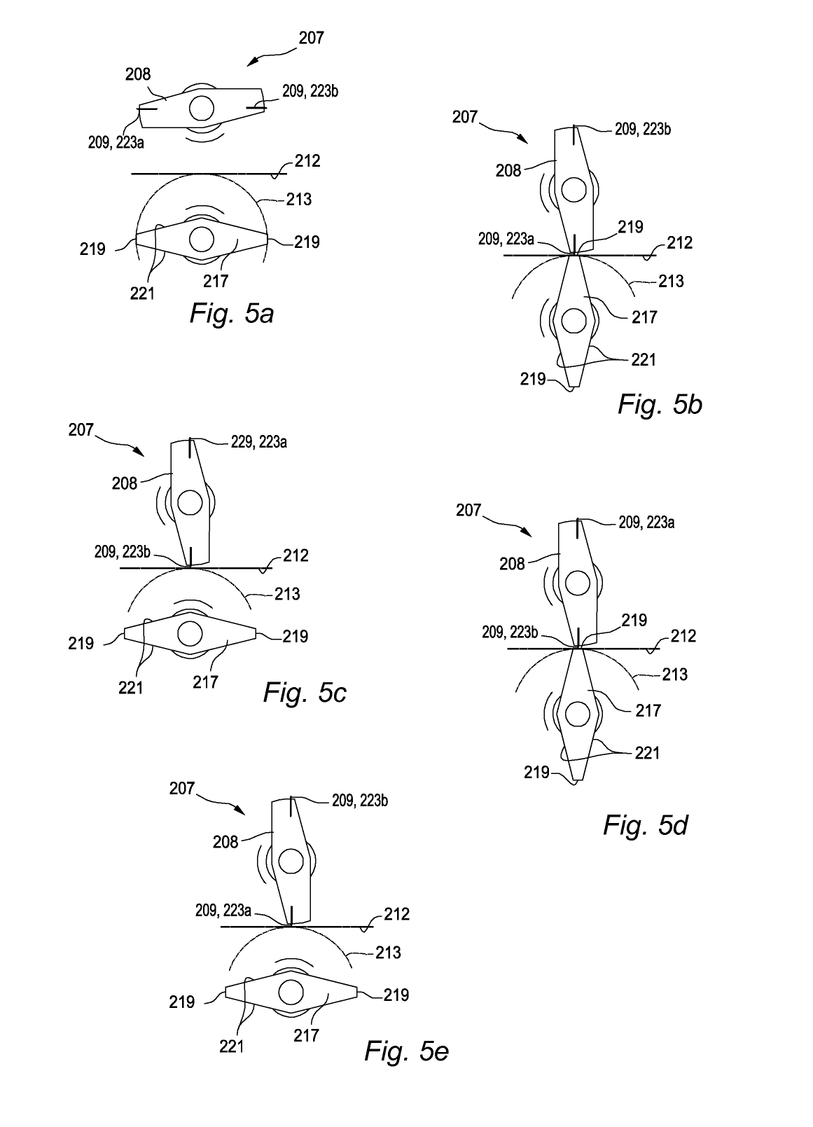

An equipment for transversal perforation on the fly, according to the invention, represented with 206 in FIGS. 4 and 5a±5e, comprises a perforating device 207 having a blade support 208 with at least a perforating blade 209 and structure similar to the one of the blade support 113. The device 207 has possibility of executing “jumps” in the perforations and is represented to process a continuous form 211. The form is in continuous movement at velocity Vm on a movement surface 212 and is kept in tension by feeding means not represented in the drawings.

The blade support 208 is provided for rotation, with commutation through a condition of interference of the blade against a geometric surface 213 of cylindrical development, in a corresponding operative area of the movement surface 212. A blade servomechanism 214 is actuatable for rotating the support blade 208 with the edge of the blade in synchronism with the form 211. The perforation is effected at a requested position against a contrast surface corresponding to the geometric surface 213. A control circuit member 216 drives the blade servomechanism 214 according to rules substantially equal to those provided for similar components of the equipment 111 represented in FIG. 1.

According to the invention, the perforating device 207 includes a contrast member 217, of limited inertia, which is provided for rotation in condition of substantially parallelism with the blade support 208 and is driven by a contrast servomechanism 218. The contrast member 217 has an active section or more active sections 219 for the perforation and a remaining inactive section or more remaining inactive sections 221. The contrast servomechanism 218 is provided for rotating the contrast member 217 between a condition of perforation and a condition of non-perforation of the blade 209 or the selected blade.

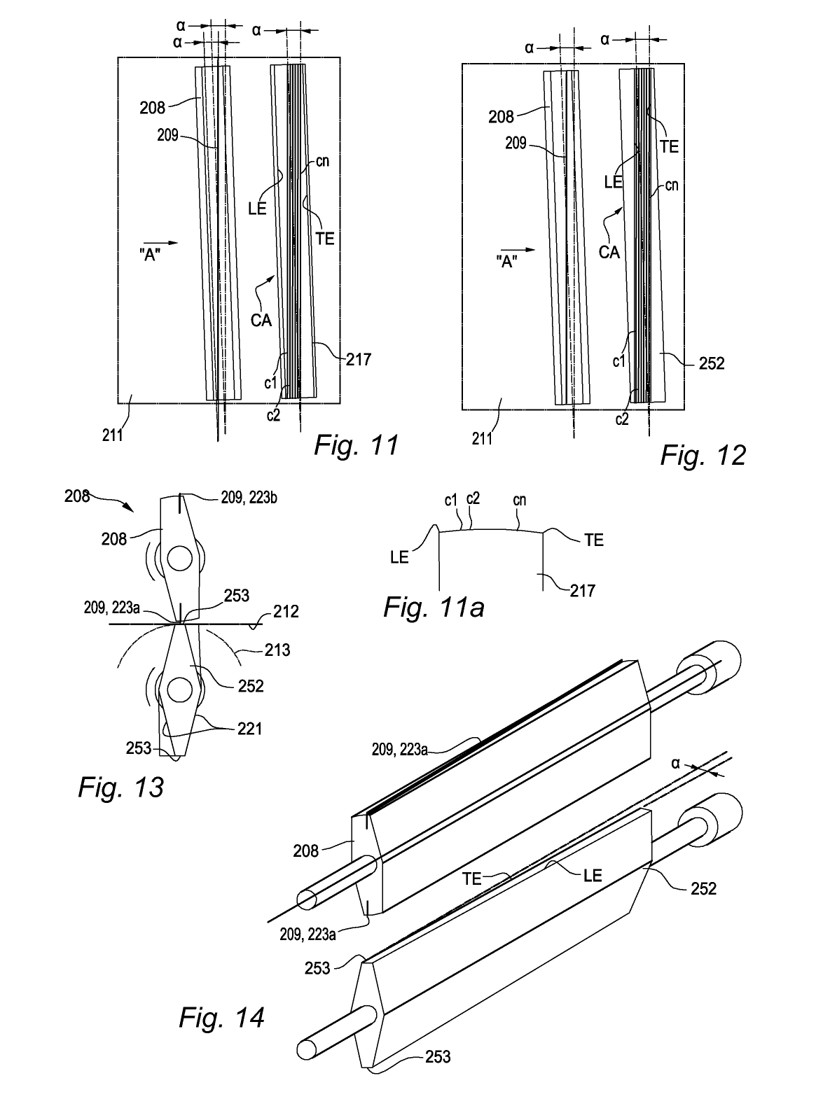

Following a known technique, the axes of the blade support 208 (See FIG. 11) and the contrast member 217 are inclined of a small angle “a” of about 1° with respect to a directrix perpendicular to direction of movement “A” of the form 211. Similarly, the perforating blade 209 is arranged along a helix on the support 208 and has an edge inclined as the blade support and the contrast roller.

The active section or each of the active sections 219 is constituted by a cylindrical sector having the same generatrix of the geometric surface 213. On the other hand, the inactive section or each of the inactive sections 221 is constituted by a surface having profile depressed with respect to the surface 213. The active section or each of the active sections 219 can be positioned in a condition of tangency with the trajectory of the blade and the movement surface 212 of the continuous form 211. Thus, the active section defines the contrast surface corresponding to the surface 213, functional to the perforation on the operative area of the blade 209 or the selected blade. As an example, the contrast member 217 is constituted by a two-lobes shaped bar, of substantially rectangular section, supported in the rotation by a median axis, and limited by the cylindrical sectors which define the active sections 219. Each sector of the active section extends for about 8°±16°, to define an inertia of the contrast member, which is much more less than 1/10 of the inertia of a theoretical contrast member of cylindrical shape.

The inactive section or each of the inactive sections 221 can be positioned in front of the operative area of the selected blade 209, spaced away with respect to the movement surface 212. For the condition of perforation, the control member 216 drives the contrast servomechanism by rotating the contrast member 217 with the active section or one of the active sections 219 in the condition of tangency and in synchronism with the form 211. For the condition of non-perforation, the control member 216 drives the servomechanism 218 by positioning the contrast member 217, still or in movement, with the inactive section or one of the inactive sections 221 spaced away from the movement surface of the form 211 and, therefore, from the operative area of the selected blade.

The blade servomechanism 214 can keep the blade in movement after the perforation at a given basic velocity and selectively executing an idle run of the blade between two successive perforations, while the contrast servomechanism 218 positions the contrast member 217 with the depressed sections spaced away from the movement surface of the form 211. It is carried out for obtaining high-speed perforations, by mounting on the blade support 208 two or more blades of a same length. Mounting two or more blades of different lengths allows carrying out selectively different typologies of perforations.

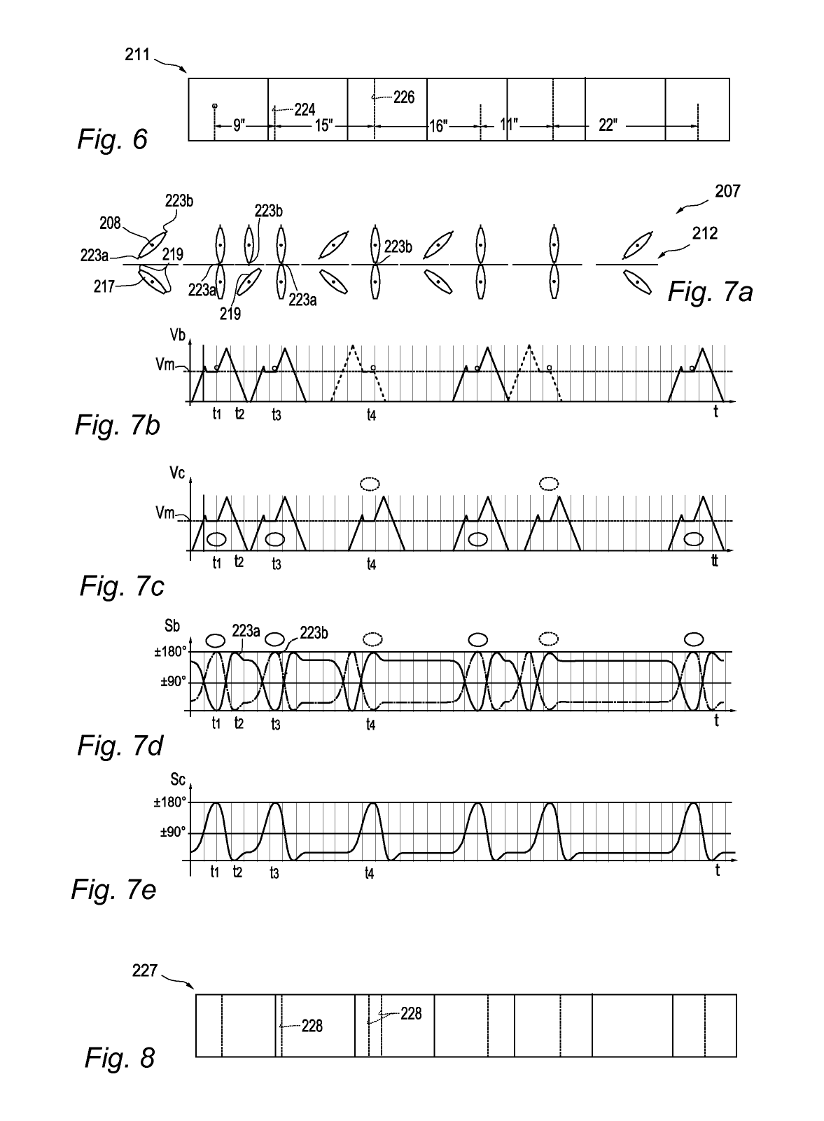

In the FIGS. 7a±7e, diagrams of the perforating device 207 are shown, in which the blade support 208 (FIG. 7a) carries two blades 223a and 223b of different lengths for perforating the form 211 (FIG. 6) with respective sections of perforation 224 and 226 of different lengths and varying positions in the single sheets.

In a blade velocity “Vb” versus time “t” (FIG. 7b) diagram, the blade support 208 is accelerated and uniformed by the blade servomechanism 214. In detail, the velocity of the blade 223a is increased up to reach the velocity of the form Vm and keep the velocity Vm, at the instant “t1”, on the defined point of perforation.

Simultaneously, as represented in a contrast velocity “Vc” versus time “t” (FIG. 7c) diagram, the contrast servomechanism 218 accelerates the contrast member 217, up to reaching and keeping the velocity of the active section 219 at the value “Vm” to obtain the condition of tangency with the movement surface 212 of the form at the instant “t1”, for the contrast against the blade 223a. It is also shown in the angular shifting of the blades “223a and 223b—time “t” diagram of FIG. 7d and in the contrast shifting “Sc”—time “t” diagram of FIG. 7e.

Perforating a first short section 224 occurs whereby for the action of the blade 221a on the form 222, at instant “t1”, against the active section 219. Then, the blade servomechanism and the contrast servomechanism continue with acceleration, braking and following acceleration of the blade support and the contrast member. The phases are such that the contact of the other blade 223b with the form occurs at instant “t2” in correspondence with the inactive sector 219 spaced away from the movement surface and, therefore, with “jump”, without any action of perforation.

The control circuit member 216 drives the blade servomechanism 214 and the contrast servomechanism 218 by further accelerating the blade support and the contrast member to reach the condition of tangency of the perforating blade 221a and the active section 219 with the movement surface 212, at the instant “t3”, for perforating the second section 224.

For perforating a first longer section 226, the blade support and the contrast member are progressively accelerated, braked and arrested. Then, with different laws of motion, the control member 216 drives the blade servomechanism 214 and the contrast servomechanism 218 to accelerate the blade support and the contrast member, up to putting at the value Vm the velocities of the blade 223b and of one of the active section 219 and reaching the condition of tangency with the movement surface of the form at the instant “t4”, for perforating the section 226 by the blade 221b.

The perforating device 207, when it works with two identical blades 209, for instance on a continuous form 227 (FIG. 8), can carry out close perforations 228 at high velocity. The manner is the one regarding the perforations on the form 211 and, therefore, is not here described.

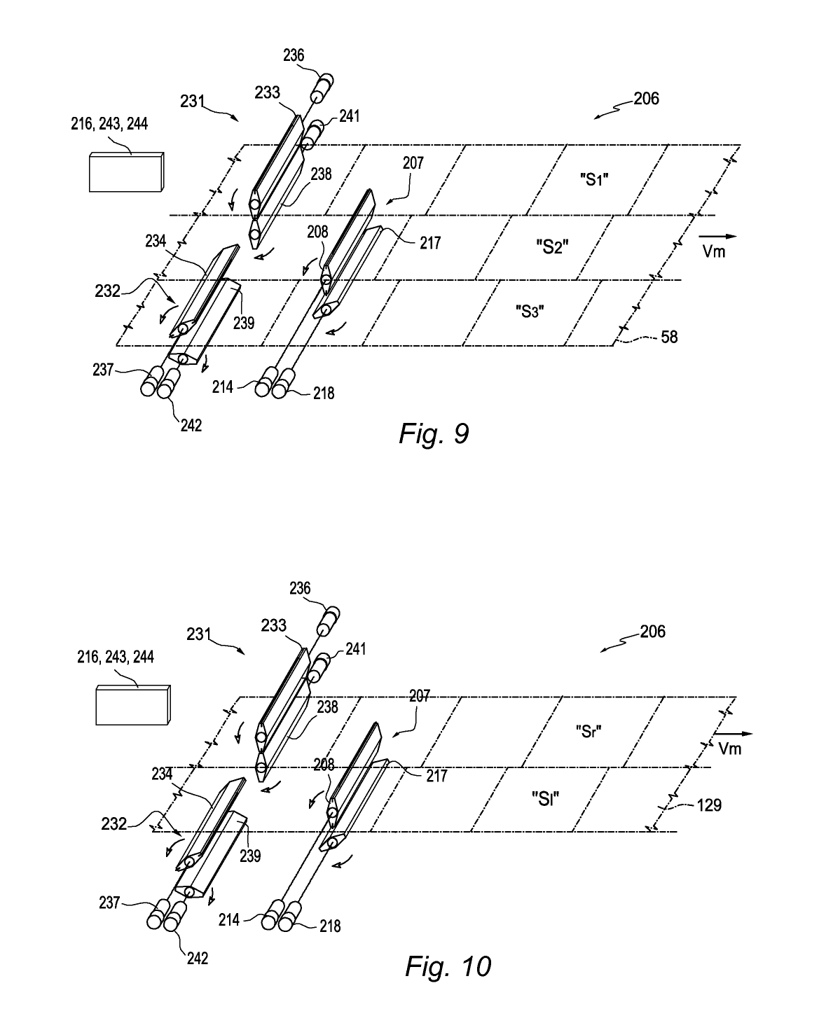

For processing forms 58 (FIG. 9) to be separated in three longitudinal sections, the equipment 206 includes another perforating device 231 and a further perforating device 232 similar to the device 207. The perforating devices 231, and 232 have, in detail, respective blade supports 233 and 234 driven by servomechanisms blades 236 and 237, contrast members 238 and 239 driven by contrast servomechanisms 241 and 242 and control circuit members 243 and 244 for performing the transversal perforations on the sections “S1”, “S2” and “S3”, as described in the above cited patent application TO 2009A000102.

Also the equipment 206 can process forms 129 (FIG. 10) to be separated in two longitudinal sections by the perforating devices 207 and 231. For processing both the typologies of forms, the blade supports 208 and 233 have, therefore, a blade for carrying out the transversal perforations “Sr” and “S1” on the forms 129 to be divided in two longitudinal sections and another blade for carrying out, in alternative, the transversal perforations on the forms 59 to be divided in three longitudinal sections. Suitably, the active sections of the contrast members 217 and 238 perform the action of contrast for the blades on the forms to be divided in two sections and/or for the blades on the forms to be divided in three sections.

According to another feature of the invention, the perforating blade can be contrasted by different contrast areas Ca of the active sections 219 (FIG. 11), whereby reducing permanent deformations and wear of the contrast member 217. To this end, the control circuit member 216 (FIG. 4) provides a phase varying circuit 251, which varies progressively the phase for the member 217 such to arrange the areas of contrast Ca on positions c1, c2, . . . cn of the active sections 219 variable between leading edges LE (FIG. 11a) and a trailing edges TE of the contrast member 217. For example, the phase varying circuit 251 includes a counter for the perforating cycles, which increases the phase of the member 217 from zero for the position of the area of contrast associated to the leading edges LE to the maximum for the position associated to the trailing edges TE and following return to zero. Of course other circuits, as a random phase generator, working within the limits LE and TE can be provided.

With the contrast member 217 of FIGS. 11 and 11a formed by the rectilinear bar, only a partial width of the active sections 219 can be used for the contrast of the perforating blades. In fact, the inclination of the blades has the result that the active areas close to the edges LE and TE are shorter and cannot be used as contrast for the blades.

A contrast member 252 of FIGS. 12 and 13 is formed by a bar of substantially rectangular section, but having a helicoid shape with inclination of an angle “a” identical to the one of the perforating blades. The respective active sections, represented with 253, are also of helicoid shape and allow the full width between the leading edges LE and the trailing edges TE to be active for the contrast areas Ca without any increasing of the inertial masses.

Naturally, the principle of the invention remaining the same, the embodiments and the details of construction can broadly be varied with respect to what has been described and illustrated, by way of non-limitative example, without by this departing from the ambit of the present invention.

For instance, the equipment 206 can provide more than three perforating devices for forms to be divided in more than three sections. The perforating device can also work with blade supports having more than two blades. However, also the number of the active sections and their conformation can be different from what has been above described. Typically it is achieved by providing a blade support mounting four perforating blades and a contrast member having four active sections and four inactive sections.

We claim:

1. An equipment for transversal perforation, on the fly, of continuous forms in movement, comprising a given perforating device including at least a perforating blade, a contrast surface and a blade servomechanism, wherein the perforating blade is mounted on a blade support provided for rotation in condition of interference with the form and wherein the blade servomechanism is provided for rotating the support blade with the perforating blade in synchronism with the form and perforation, in a corresponding operative area, against the contrast surface, said equipment further comprising:
a contrast member provided for rotation in condition of substantially parallelism with the blade support and having an active section or more active sections and an inactive remaining section or more inactive remaining sections; and
a contrast servomechanism for rotating the contrast member between a condition of perforation and a condition of non-perforation; wherein
the active section or each active section is positionable in condition of tangency with the trajectory of the perforating blade for defining the contrast surface in the operative area, while the inactive section or each inactive section is spaced away, in the use, with respect to the trajectory of the blade; and wherein
the contrast servomechanism, for the condition of perforation, rotates the contrast member with the active section or one of the active sections in the condition of tangency with the operative area and in synchronism with the form while, for the condition of non-perforation, the contrast servomechanism positions the contrast member, at rest or in movement, with the inactive section or one of the inactive sections spaced away from the trajectory of the perforating blade in said operative area.

2. Equipment according to claim 1, wherein, after the perforation, the blade servomechanism keeps the blade in movement at a given basic velocity and selectively executes an idle run of the blade between two successive perforations; and wherein the contrast servomechanism positions or keeps in motion the contrast member so that, during the idle run, the inactive section or one of the inactive section is spaced away from the trajectory of the blade.

3. Equipment according to claim 1, wherein the blade support mounts more blades of identical length for carrying out high-speed close perforations.

4. Equipment according to claim 1, wherein the blade support mounts more blades of different lengths for selectively carrying out different typologies of perforations.

5. Equipment according to claim 4, wherein the contrast servomechanism, in the condition of perforation, rotates the contrast member for the condition of interference of one of said blades to carry out the typology of perforation associated with the perforating blade and for the inoperative condition of the other blade or the other blades.

6. Equipment according to claim 3, wherein the blade support mounts two blades, while the contrast member includes two active sections and two inactive sections.

7. Equipment for on the fly perforation of continuous forms according to claim 6, wherein the contrast member includes two active sections and two inactive sections and wherein each active section extends angularly for 8°±16°

8. Equipment according to claim 3, wherein the blade support mounts four perforating blades, while the contrast member includes four active sections and four inactive sections.

9. Equipment for on the fly perforation of continuous forms according to claim 1, wherein the contrast member is of limited inertia and wherein the active section or each active section has a limited angular extension.

10. Equipment for on the fly perforation of continuous forms according to claim 1, wherein the contrast member has an inertial mass which is less than 1/10 of the inertial mass of a theoretical contrast member of cylindrical shape.

11. Equipment for on the fly perforation of continuous forms according to claim 1, wherein it can be used for processing continuous forms in movement to be divided in two longitudinal sections and comprises another transversal perforating device similar to said given perforating device for carrying out transversal perforations in the continuous forms to be divided in two longitudinal sections.

12. Equipment for on the fly perforation of continuous forms according to claim 1, wherein it can be used for processing continuous forms in movement to be divided in three longitudinal sections and comprises another transversal perforating device and a further transversal perforating device, similar to said given perforating device, for executing transversal perforations in the continuous forms to be divided in three longitudinal sections.

13. Equipment for on the fly perforation for continuous forms according to claim 11, wherein it can also be used for processing continuous forms in movement to be divided in two longitudinal sections and wherein the other transversal perforating device and the further transversal perforating device have each one a perforating blade for the continuous forms to be divided in two sections, provided for carrying out transversal perforations on the forms to be divided in two longitudinal sections and a perforating blade for forms to be divided in three sections, provided for executing, in alternative, the transversal perforations on the forms to be divided in three longitudinal sections, and wherein the active sections of the contrast member determine the action of contrast for the blade for forms to be divided in two sections and/or for the blade for forms to be divided in three sections.

14. Equipment for on the fly perforation of continuous forms according to claim 1, wherein the perforating blade or each perforating blade can be contrasted by different contrast areas of the active section or each active section and wherein the contrast servomechanism is provided for varying progressively the phase of the contrast member such to arrange the areas of contrast on positions of the active section or each active section variable between a leading edge and a trailing edge of the active section or each active section.

15. Equipment according to claim 13, wherein the perforating blade or each perforating is inclined with respect to the axis of the support blade and wherein the active section or each active section of the contrast member is of helicoid shape with inclination corresponding to the one of the perforating blade.

16. An equipment for transversal perforation, on the fly, of continuous forms in movement along a respective surface, comprising a perforating device with a blade support actuated in the rotation by a blade servomechanism and blades in synchronism with the continuous form for the perforation at the passage of one of the blades, said equipment being characterized in that it further comprises:
a contrast member with active sections and remaining inactive sections having possibility of rotation parallel to the blade support; and
a contrast servomechanism for rotating the blade support between a condition of perforation, in synchronism with the continuous form, and a condition of non-perforation; and wherein,
in the condition of perforation, each active section has function of contrast for the blades, while, in the condition of non-perforation, each inactive section is spaced away from the trajectory of the blades whereby avoiding the perforation at the passage of one of said blades.

17. An equipment for transversal perforation, on the fly, of continuous forms in movement, comprising a given perforating device including at least a perforating blade, a contrast surface and a blade servomechanism, wherein the perforating blade is mounted on a blade support, provided for rotation in condition of interference with the form and wherein the blade servomechanism is provided for rotating the support blade with the perforating blade in synchronism with the form and perforation, in a corresponding operative area, against the contrast surface, said equipment further comprising:
a contrast member provided for rotation in condition of substantially parallelism with the blade support and having an active section or more active sections and an inactive remaining section or more inactive remaining sections; and
a contrast servomechanism for rotating the contrast member between a condition of perforation and a condition of non-perforation; wherein
the active section or each active section is positionable in condition of tangency with the trajectory of the perforating blade for defining the contrast surface in the operative area, while the inactive section or each inactive section is spaced away, in the use, with respect to the trajectory of the blade;
wherein the contrast member is of limited inertia and the active section or each active section has a limited angular extension;
the contrast servomechanism, for the condition of perforation, rotates the contrast member with the active section or one of the active sections in the condition of tangency with the operative area and in synchronism with the form while, for the condition of non-perforation, the contrast servomechanism positions the contrast member, at rest or in movement, with the inactive section or one of the inactive sections spaced away from the trajectory of the perforating blade in said operative area; and
the perforating blade or each perforating blade can be contrasted by different contrast areas of the active section or each active section; and
wherein the contrast servomechanism is provided for varying progressively the phase of the contrast member such to arrange the areas of contrast on positions of the active section or each active section variable between a leading edge and a trailing edge of the active section or each active section.

18. Equipment according to claim 16, wherein the perforating blade or each perforating blade is inclined with respect to the axis of the support blade and wherein the active section or each active section of the contrast member is of helicoid shape with inclination corresponding to the one of the perforating blade.

19. Equipment according to claim 16, wherein the blade support mounts two blades while the contrast member includes two active sections and two inactive sections and wherein each active section extends angularly for 8°±16°.
